(19) United States
(12) Patent Application Publication
(10) Pub. No.: US 2020/0302803 A1
(43) Pub. Date: Sep. 24, 2020

(54) UNMANNED AERIAL VEHICLE RETURN METHOD AND DEVICE, STORAGE MEDIUM AND UNMANNED AERIAL VEHICLE

(71) Applicant: AUTEL ROBOTICS CO., LTD., Shenzhen (CN)

(72) Inventor: Jian YANG, Shenzhen (CN)

(21) Appl. No.: 16/898,731

(22) Filed: Jun. 11, 2020

Related U.S. Application Data
(63) Continuation of application No. PCT/CN2017/115418, filed on Dec. 11, 2017.

(51) Int. Cl. G08G 5/00; B64C 39/02; G05D 1/10

(52) U.S. Cl. CPC G08G 5/0034; B64C 39/024; G05D 1/101; B64C 2201/146; B64C 2201/021; B64C 2201/042; G08G 5/0047

(57) ABSTRACT

The present application relates to an unmanned aerial vehicle return method and device, a storage medium and an unmanned aerial vehicle. A distance between a first return point and a current location of a terminal is determined when a return condition of the unmanned aerial vehicle is triggered. A second return point is determined according to the current location of the terminal when the distance is greater than a preset distance threshold. A flight path is determined according to a current location of the unmanned aerial vehicle and the second return point, and the unmanned aerial vehicle returns to the second return point according to the flight path. The unmanned aerial vehicle can update a return point according to a location of a user in the foregoing manners, so that returning is more intelligent, thereby improving the user experience.

This application is a continuation application of International Application No. PCT/CN2017/115418, filed Dec. 11, 2017, which is incorporated herein by reference in its entirely.

### BACKGROUND

### Technical Field

The present application relates to the technical field of unmanned aerial vehicles, and in particular, to an unmanned aerial vehicle return method and device, a storage medium and an unmanned aerial vehicle.

### Related Art

Unmanned aerial vehicles (UAVs), also referred to as drones, are characterized in low costs, quick deployment and zero casualty, and therefore are widely applied to the military field and the civil field.

Returning is an important step for the unmanned aerial vehicle to land safely. The unmanned aerial vehicle can be controlled by a remote-control device to return or can return automatically. That is, the unmanned aerial vehicle can plan a path and returns to a flight start point.

However, during flight of the unmanned aerial vehicle, the user location varies. That is, the user gets away from the flight start point. In such a case, the unmanned aerial vehicle can return only to the flight start point. Therefore, the user cannot directly obtain the returned unmanned aerial vehicle, resulting in low user experience.

### SUMMARY

According to the solutions of the embodiments, an unmanned aerial vehicle return method and device, a storage medium and an unmanned aerial vehicle are provided.

An unmanned aerial vehicle return method, including:

determining a distance between a first return point and a current location of a terminal when a return condition of an unmanned aerial vehicle is triggered;

determining a second return point according to the current location of the terminal when the distance is greater than a preset distance threshold; and

determining a flight path according to a current location of the unmanned aerial vehicle and the second return point, and returning to the second return point according to the flight path.

An unmanned aerial vehicle return device, including:

a distance determining module, configured to determine a distance between a first return point and a current location of a terminal when a return condition of an unmanned aerial vehicle is triggered;

a second return point determining module, configured to determine a second return point according to the current location of the terminal when the distance is greater than a preset distance threshold; and

a return module, configured to determine a flight path according to a current location of the unmanned aerial vehicle and the second return point, and to return to the second return point according to the flight path.

A computer readable storage medium, storing a computer program, where the program implements the following steps when executed by a processor:

determining a distance between a first return point and a current location of a terminal when a return condition of an unmanned aerial vehicle is triggered;

determining a second return point according to the current location of the terminal when the distance is greater than a preset distance threshold; and

determining a flight path according to a current location of the unmanned aerial vehicle and the second return point, and returning to the second return point according to the flight path.

An unmanned aerial vehicle, including a memory, a processor and a computer program which is stored in the memory and runs on the processor, where the processor implements the following steps when executing the computer program:

determining a distance between a first return point and a current location of a terminal when a return condition of the unmanned aerial vehicle is triggered;

determining a second return point according to the current location of the terminal when the distance is greater than a preset distance threshold; and

determining a flight path according to a current location of the unmanned aerial vehicle and the second return point, and returning to the second return point according to the flight path.

In the embodiments of the present application, the distance between the first return point and the current location of the terminal is determined when the return condition of the unmanned aerial vehicle is triggered, and the second return point is determined according to the current location of the terminal when the distance is greater than the preset distance threshold. The flight path is determined according to the current location of the unmanned aerial vehicle and the second return point, and the unmanned aerial vehicle returns to the second return point according to the flight path. The unmanned aerial vehicle can update a return point according to a location of a user in the foregoing manners, so that returning is more intelligent, thereby improving the user experience.

### BRIEF DESCRIPTION OF THE DRAWINGS

FIG. 1 is a diagram of an application environment of an unmanned aerial vehicle return method according to an embodiment;

FIG. 2 is a diagram of an internal structure of an unmanned aerial vehicle according to an embodiment;

FIG. 3 is a flowchart of an unmanned aerial vehicle return method according to an embodiment;

FIG. 4 is a schematic diagram of a flight path of an unmanned aerial vehicle return method according to an embodiment;

FIG. 5 is a schematic structural diagram of an unmanned aerial vehicle return device according to an embodiment; and

FIG. 6 is a schematic structural diagram of an unmanned aerial vehicle return device according to another embodiment.

### DETAILED DESCRIPTION

The present application is further described below with reference to the accompanying drawings and the embodiments. It should be understood that the specific embodiments described herein are merely intended to explain the present application, but are not intended to limit the present application.

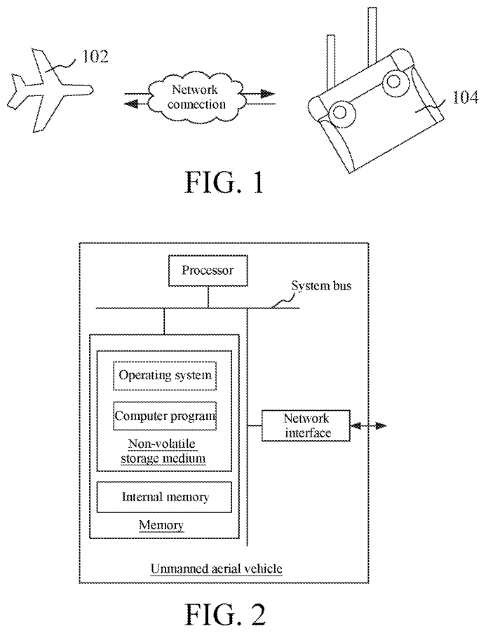

An unmanned aerial vehicle return method provided in the embodiments of the present application may be applied to an environment shown in FIG. 1. As shown in FIG. 1, an unmanned aerial vehicle 102 is connected to a terminal 104 through a network. The terminal 104 may be a remote control, a mobile terminal (for example, a telephone, a tablet computer or a computer) or a wearable device that controls the unmanned aerial vehicle 102. Certainly, the terminal 104 may alternatively be another device which can control the unmanned aerial vehicle 102. In the application environment shown in FIG. 1, the unmanned aerial vehicle can implement any of the following return methods.

FIG. 2 is a schematic diagram of an internal structure of an unmanned aerial vehicle according to an embodiment. As shown in FIG. 2, the unmanned aerial vehicle includes a processor, a memory and a network interface that are connected by using a system bus.

The processor is configured to provide calculation and control capabilities, so as to control flight of the unmanned aerial vehicle, for example, plan a flight path for the unmanned aerial vehicle or control a flight speed or a flight altitude of the unmanned aerial vehicle. Herein, the processor described in the embodiments of the present application may include various processors, for example, a visual processor and a flight control processor. Different processors are configured to implement different functions. Herein, the processor may include a processing unit, an image processor or an integrated circuit. This is not limited herein.

The memory is configured to store data, programs and the like. The memory stores at least one computer program. The computer program may be executed by the processor, to implement the return method that is applicable to the unmanned aerial vehicle and that is provided in the embodiments of the present application. The memory may include a non-volatile storage medium such as a magnetic disk, an optical disc or a read-only memory (ROM), or may include a random access memory (RAM) and the like. For example, in an embodiment, the memory includes a non-volatile storage medium and an internal memory. The non-volatile storage medium stores an operating system, a computer program, data and the like. The computer program may be executed by the processor, to implement any of the unmanned aerial vehicle return method provided in the following embodiments. The internal memory provides an operation environment of high speed cache for the operating system, the computer program, the data and the like in the non-volatile storage medium.

The network interface may include an Ethernet card or a wireless network interface card, and is configured to implement communications between the unmanned aerial vehicle and a terminal.

Certainly, the unmanned aerial vehicle may further include other structural components, such as a central housing, an arm, a power system including a plurality of motors, a pan-tilt-zoom, and various sensors. This is not limited herein.

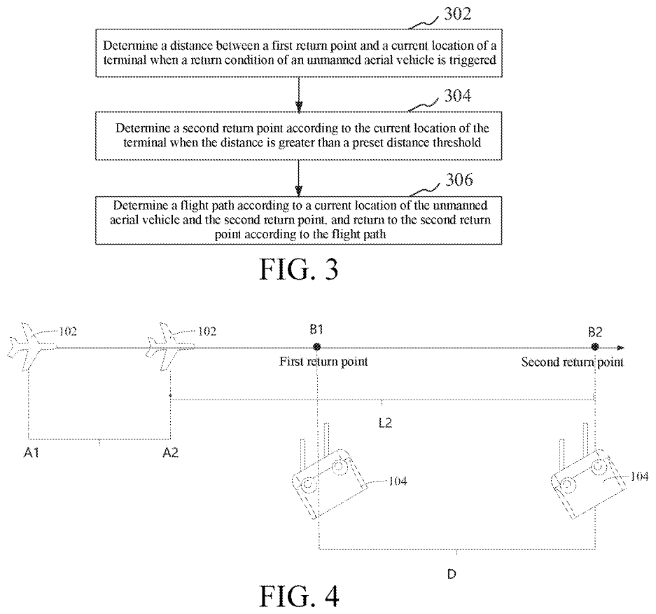

In an embodiment, as shown in FIG. 3, an unmanned aerial vehicle return method is provided. Descriptions are made by using that the method is applied to the unmanned aerial vehicle in FIG. 1 as an example, including:

Step 302. Determine a distance between a first return point and a current location of a terminal when a return condition of an unmanned aerial vehicle is triggered.

The return condition may include at least one of the following conditions: the unmanned aerial vehicle detects that a remaining electricity quantity of the unmanned aerial vehicle is less than or equal to an electricity quantity threshold; or the unmanned aerial vehicle completes a flight task; or the unmanned aerial vehicle receives a return instruction; or the unmanned aerial vehicle fails to communicate with the terminal.

When the return condition of the unmanned aerial vehicle is triggered, the unmanned aerial vehicle determines a recorded first return point. The first return point may be a flight start point of the unmanned aerial vehicle, or may be a return point of the unmanned aerial vehicle that is updated during flight. This is not limited herein.

The unmanned aerial vehicle may obtain the current location of the terminal in real time. For example, if a GPS module is disposed in the terminal, the unmanned aerial vehicle may obtain GPS data of the terminal, and further determine the current location of the terminal according to the GPS data. If no GPS module is disposed in the terminal, the unmanned aerial vehicle may obtain the current location of the terminal in other manners. For example, the unmanned aerial vehicle determines the current location of the terminal by using a current location of another user terminal. The current location of the terminal and the current location of the another user terminal are both used to indicate a current location of a user. When the unmanned aerial vehicle is connected to a plurality of terminals, a terminal having the highest positioning accuracy may be filtered from the terminals, and a location of the terminal having the highest positioning accuracy is further obtained.

After the first return point and a current location of a final work section are determined, the distance between the first return point and the current location of the terminal may be determined. Moreover, whether the distance between the first return point and the current location of the terminal is greater than a preset distance threshold is determined. The preset distance threshold is related to an environment in which the unmanned aerial vehicle is located. That is, the preset distance threshold varies if the unmanned aerial vehicle is in different environments. For example, if the environment in which the unmanned aerial vehicle is currently located is a terrestrial environment, the first return point and the current location of the terminal can be determined according to a first preset distance threshold which is related to the terrestrial environment; or if the environment in which the unmanned aerial vehicle is currently located is a water environment, the first return point and the current location of the terminal can be determined according to a second preset distance threshold which is related to the water environment. An association relationship between the environment and the preset distance threshold may be pre-stored in the unmanned aerial vehicle. Certainly, the preset distance threshold may alternatively be related to a viewable range of a user, or related to a location of the first return point or related to a combination of the foregoing factors. This is not limited herein.

Step 304. Determine a second return point according to the current location of the terminal when the distance between the first return point and the current location of the terminal is greater than the preset distance threshold.

If it is determined that the distance between the first return point and the current location of the terminal is greater than the preset distance threshold, it indicates that the user is far away from the first return point and the return point needs to be updated. Further, the second return point can be determined according to the current location of the terminal. That is, a return point recorded by the unmanned aerial vehicle is updated from the first return point into the second return point.

Optionally, the preset distance threshold may be determined according to a farthest viewable range of the user, or determined according to an environment in which the aerial vehicle is located or determined according to a combination of the two manners.

For example, to satisfy that the return point is within the farthest viewable range of the user, the return point needs to be within a range of the preset distance threshold. In this case, the user can see the unmanned aerial vehicle which is at the return point. For example, on a flat land, the farthest viewable range of the user, that is, the preset distance threshold, is 100 m. Therefore, it is determined that a location of the second return point is any location having a distance within a preset range to the current location of the terminal. That is, it is determined that the second return point is within a circle using the current location of the terminal as a center and using the preset distance threshold of 100 m as a radius.

In an embodiment, the determining, according to the current location of the terminal, that the second return point is any location having a distance within the preset range to the current location of the terminal includes: determining, according to the current location of the terminal, that the second return point is the current location of the terminal.

Step 306. Determine a flight path according to a current location of the unmanned aerial vehicle and the second return point, and return to the second return point according to the flight path.

Optionally, in a process in which the unmanned aerial vehicle flies according to the flight path, if it is determined that a location of the terminal has been updated, a distance between the second return point and the current location can be continued to be determined. If the distance is greater than the preset distance threshold, the return point may be further updated, to determine a new return point and re-plan a return path, that is, a flight path from the unmanned aerial vehicle to the new return point.

In this embodiment of the present application, the distance between the first return point and the current location of the terminal is determined when the return condition of the unmanned aerial vehicle is triggered, and the second return point is determined according to the current location of the terminal when the distance is greater than the preset distance threshold. The flight path is determined according to the current location of the unmanned aerial vehicle and the second return point, and the unmanned aerial vehicle returns to the second return point according to the flight path. The unmanned aerial vehicle can update the return point according to a location of the user in the foregoing manners, so that returning is more intelligent, thereby improving the user experience.

Referring to FIG. 4, FIG. 4 is an application schematic diagram of an unmanned aerial vehicle return method.

As shown in FIG. 4, when an unmanned aerial vehicle 102 flies to a location A1, a return condition is triggered and the unmanned aerial vehicle 102 needs to return. In this case, a location of a terminal 104 that is obtained by the unmanned aerial vehicle is a location B1. It is default that the location of the terminal 104 is a location of a user. Moreover, a stored return point obtained by the unmanned aerial vehicle is a first return point. The first return point may be an initial return point of the unmanned aerial vehicle or may be a return point updated based on other conditions during flight of the unmanned aerial vehicle. Herein, the initial return point refers to a location point at which the unmanned aerial vehicle takes off.

Further, the unmanned aerial vehicle can determine a distance between the location B1 and the first return point. If the distance is smaller than a preset distance threshold, it indicates that the location of the terminal does not obviously change, that is, the first return point is within a viewable range of the user, and the unmanned aerial vehicle can determine to return to the first return point. Specifically, the unmanned aerial vehicle can determine a flight path from the location A1 to the first return point and return according to the flight path. Herein, a manner for determining the flight path is not limited in the embodiments of the present application.

It should be noted that in this embodiment of the present application, determining a distance between the terminal 104 and the return point refers to determining a horizontal distance at a same horizontal plane between the terminal 104 and the return point. That is, the heights of a location point of the terminal 104 and the return point are not considered. The return point may have a relative height of the location of the terminal, or may not have the relative height; this not considered herein.

During the returning, if the location of the terminal changes significantly, for example, as shown in FIG. 4, the location changes from the location B1 to a location B2, in this process, the aerial vehicle returns from the location A1 to a location A2. In this case, the unmanned aerial vehicle may obtain the location of the terminal according to a preset period or in real time. For example, when the unmanned aerial vehicle obtains that the location of the terminal is the location B2, the unmanned aerial vehicle may determine whether a distance between the location B2 and the first return point is greater than or equal to the preset distance threshold. If the distance between the location B2 and the first return point is greater than or equal to the preset distance threshold, it indicates that the return point needs to be updated, and a second return point may be determined according to the location B2. In addition, a return point stored in the unmanned aerial vehicle is updated from the first return point into the second return point.

Specifically, determining the second return point according to the location B2 may refer to determining that the second return point is a location having a distance within a preset range to the location B2. In a case, it may be determined that the second return point is the location B2.

Further, the unmanned aerial vehicle determines a flight path from the location A2 to the location B2 according to the location A2 at which the unmanned aerial vehicle is currently located and the location B2, and returns according to the flight path. Similarly, in a process of returning to the second return point, the unmanned aerial vehicle may continue to update the return point in the foregoing manner until the unmanned aerial vehicle returns to the location of the terminal.

In this embodiment, if it is determined that the second return point is within a circle using a current location of the terminal as a center and using a preset distance threshold of 100 m as a radius, a location of the second return point is further defined to be at the current location of the terminal. In this way, in a returning process of the unmanned aerial vehicle, when a distance between the first return point and the current location of the terminal is greater than the preset distance threshold, the second return point is updated into the current location of the terminal. Certainly, the unmanned aerial vehicle can automatically return to a location which slightly deviates from the current location of the terminal, avoiding a collision with the user who manipulates the unmanned aerial vehicle. In this way, the aerial vehicle directly returns to a location nearby the current location of the terminal, and the user can pick up the unmanned aerial vehicle nearly without walking. Therefore, the unmanned aerial vehicle is very convenient.

In an embodiment, the preset distance threshold is related to an environment in which the terminal is located.

The unmanned aerial vehicle obtains an environmental map of the location at which the unmanned aerial vehicle is located, identifies a flight scene according to the environmental map, and correspondingly sets an optimal viewing distance, that is, the preset distance threshold, of the user according to the identified flight scene and eyesight of the user. For example, when the identified flight scene is a flat land, a farthest viewing distance of the user is relatively large, and is usually within a range of 10 m to 100 m. The user can correspondingly set the farthest viewing distance according to the eyesight thereof. When the identified flight scene is a sea surface or a lake surface, the farthest viewing distance of the user is relatively small, and is usually within a range of 10 m to 20 m. The user can correspondingly set the farthest viewing distance according to the eyesight thereof. Certainly, when setting the preset distance threshold, the user can further comprehensively consider factors such as weather condition to set a proper value.

Several use modes may be preset on a remote control of the unmanned aerial vehicle, for example, a sea surface or lake surface mode and a flat land mode. Each mode is preset with a medium viewing distance value of the user. For example, a data value in the sea surface or the lake surface mode is 15 m and a data value in the flat land mode is 50 m. Certainly, the user can further make a fine adjustment according to the eyesight thereof and a special condition such as the current weather.

In this embodiment, the unmanned aerial vehicle obtains the environmental map of the location at which the unmanned aerial vehicle is located, identifies the flight scene according to the environmental map, and correspondingly sets the optimal viewing distance, that is, the preset distance threshold, of the user according to the identified flight scene and the eyesight of the user. Dynamically setting the preset distance threshold in this way is more suitable for the user condition and the flight scene condition, ensuring that the user can clearly see the unmanned aerial vehicle within the range of the preset distance threshold.

In an embodiment, the return condition includes: the unmanned aerial vehicle detects that a remaining electricity quantity of the unmanned aerial vehicle is less than or equal to an electricity quantity threshold; or the unmanned aerial vehicle completes a flight task; or the unmanned aerial vehicle receives a return instruction; or the unmanned aerial vehicle fails to communicate with the terminal.

In this embodiment, the unmanned aerial vehicle may be triggered to return in the following case: when the unmanned aerial vehicle detects that the remaining electricity quantity of the unmanned aerial vehicle is less than or equal to the electricity quantity threshold. A process of setting the electricity quantity threshold is: calculating a distance between the current location of the unmanned aerial vehicle and the second return point, and calculating, according to the distance, an average flight speed of the unmanned aerial vehicle, a current power consumption speed of the unmanned aerial vehicle and the remaining electricity quantity in real time, a lowest electricity quantity that can ensure the unmanned aerial vehicle to return to the second return point.

The unmanned aerial vehicle may be triggered to return when the unmanned aerial vehicle completes a flight task or receives a return instruction. Certainly, the unmanned aerial vehicle may be triggered to return when the unmanned aerial vehicle fails to communicate with the terminal. During the returning, the unmanned aerial vehicle returns according to a currently newest return point.

In an embodiment, an unmanned aerial vehicle return method is further provided. The method further includes: calculating a return time according to the distance between the current location of the unmanned aerial vehicle and the second return point and a flight speed of the unmanned aerial vehicle; and sending the return time to the terminal, the terminal being configured to display the return time.

In this embodiment, the return time is calculated in real time while the unmanned aerial vehicle returns to the second return point according to a flight path which is determined according to the current location of the unmanned aerial vehicle and the second return point. The return time is the time required for the unmanned aerial vehicle to return to the second return point. Specifically, the return time is calculated in real time according to the distance between the current location of the unmanned aerial vehicle and the second return point and the flight speed of the unmanned aerial vehicle. In addition, the calculated return time is sent to the terminal in real time for display on the terminal. The user can obtain the return time by using the terminal.

When the terminal is a remote control, the unmanned aerial vehicle directly sends the return time to the remote control for display. When the terminal further includes one or more of a telephone, a tablet computer, a computer or a wearable device, the remote control further forwards the return time received from the unmanned aerial vehicle to the telephone, the tablet computer, the computer or the wearable device for display. If the unmanned aerial vehicle fails to communicate with the terminal, when the unmanned aerial vehicle is triggered to return, the user can wait for returning of the unmanned aerial vehicle according to a return time finally displayed on the terminal. If the user has not seen the unmanned aerial vehicle when the return time finally displayed on the terminal exceeds, the user needs to take corresponding measures to find the unmanned aerial vehicle.

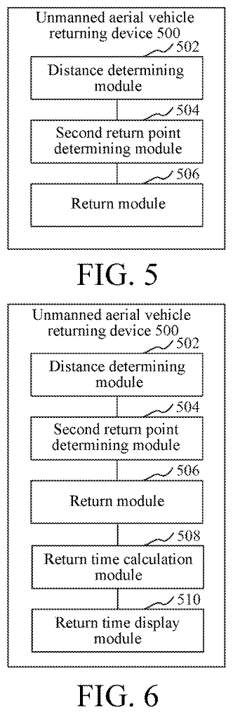

In an embodiment, as shown in FIG. 5, an unmanned aerial vehicle return device 500 is further provided. The device includes a distance determining module 502, a second return point determining module 504 and a return module 506.

The distance determining module 502 is configured to determine a distance between a first return point and a current location of a terminal when a return condition of an unmanned aerial vehicle is triggered.

The second return point determining module 504 is configured to determine a second return point according to the current location of the terminal when the distance is greater than a preset distance threshold.

The return module 506 is configured to determine a flight path according to a current location of the unmanned aerial vehicle and the second return point, and to return to the second return point according to the flight path.

In an embodiment, the second return point determining module 504 is further configured to determine, according to the current location of the terminal, that the second return point is any location having a distance within a preset range to the current location of the terminal.

In an embodiment, the second return point determining module is further configured to determine, according to the current location of the terminal, that the second return point is the current location of the terminal.

In an embodiment, the preset distance threshold is related to an environment in which the terminal is located.

In an embodiment, the return condition includes: the unmanned aerial vehicle detects that a remaining electricity quantity of the unmanned aerial vehicle is less than or equal to an electricity quantity threshold; or the unmanned aerial vehicle completes a flight task; or the unmanned aerial vehicle receives a return instruction; or the unmanned aerial vehicle fails to communicate with the terminal.

In an embodiment, the electricity quantity threshold is determined based on a distance between the unmanned aerial vehicle and the second return point and a flight speed of the unmanned aerial vehicle.

In an embodiment, as shown in FIG. 6, the device further includes a return time calculation module 508 and a sending module 510. The return time calculation module 508 is configured to calculate a return time according to a distance between the current location of the unmanned aerial vehicle and the second return point and the flight speed of the unmanned aerial vehicle.

A return time display module 510 is configured to send the return time to the terminal, the terminal being configured to display the return time.

In an embodiment, a computer readable storage medium is further provided. A computer program is stored in the computer readable storage medium, and the program implements the following steps when executed by a processor: determining a distance between a first return point and a current location of a terminal when a return condition of an unmanned aerial vehicle is triggered; determining a second return point according to the current location of the terminal when the distance is greater than a preset distance threshold; and determining a flight path according to a current location of the unmanned aerial vehicle and the second return point, and returning to the second return point according to the flight path.

In an embodiment, the foregoing program further implements the following step when executed by the processor: determining, according to the current location of the terminal, that the second return point is any location having a distance within a preset range to the current location of the terminal.

In an embodiment, the foregoing program further implements the following step when executed by the processor: determining, according to the current location of the terminal, that the second return point is the current location of the terminal.

In an embodiment, the preset distance threshold is related to an environment in which the terminal is located.

In an embodiment, the return condition includes: the unmanned aerial vehicle detects that a remaining electricity quantity of the unmanned aerial vehicle is less than or equal to an electricity quantity threshold; or the unmanned aerial vehicle completes a flight task; or the unmanned aerial vehicle receives a return instruction; or the unmanned aerial vehicle fails to communicate with the terminal.

In an embodiment, the electricity quantity threshold is determined based on a distance between the unmanned aerial vehicle and the second return point and a flight speed of the unmanned aerial vehicle.

In an embodiment, the foregoing program further implements the following step when executed by the processor: calculating a return time according to a distance between the current location of the unmanned aerial vehicle and the second return point and the flight speed of the unmanned aerial vehicle; and sending the return time to the terminal, the terminal being configured to display the return time.

In an embodiment, an unmanned aerial vehicle is further provided. The unmanned aerial vehicle includes a memory, a processor and a computer program which is stored in the memory and runs on the processor. The processor implements the following steps when executing the computer program: determining a distance between a first return point and a current location of a terminal when a return condition of the unmanned aerial vehicle is triggered; determining a second return point according to the current location of the terminal when the distance is greater than a preset distance threshold; and determining a flight path according to a current location of the unmanned aerial vehicle and the second return point, and returning to the second return point according to the flight path.

In an embodiment, the processor further implements the following step when executing the computer program: determining, according to the current location of the terminal, that the second return point is any location having a distance within a preset range to the current location of the terminal.

In an embodiment, the processor further implements the following step when executing the computer program: determining, according to the current location of the terminal, that the second return point is the current location of the terminal.

In an embodiment, the preset distance threshold is related to an environment in which the terminal is located.

In an embodiment, the return condition includes: the unmanned aerial vehicle detects that a remaining electricity quantity of the unmanned aerial vehicle is less than or equal to an electricity quantity threshold; or the unmanned aerial vehicle completes a flight task; or the unmanned aerial vehicle receives a return instruction; or the unmanned aerial vehicle fails to communicate with the terminal.

In an embodiment, the electricity quantity threshold is determined based on a distance between the unmanned aerial vehicle and the second return point and a flight speed of the unmanned aerial vehicle.

In an embodiment, the processor further implements the following step when executing the computer program: calculating a return time according to a distance between the current location of the unmanned aerial vehicle and the second return point and the flight speed of the unmanned aerial vehicle; and sending the return time to the terminal, the terminal being configured to display the return time.

A person of ordinary skill in the art may understand that all or some of the processes of the methods in the foregoing embodiments may be implemented by instructing relevant hardware by using a computer program. The program may be stored in a non-volatile computer readable storage medium. When the program is executed, the processes of the embodiments of the foregoing methods may be performed. The storage medium may be a magnetic disk, an optical disc, a ROM or the like.

The technical features of the foregoing embodiments may be freely combined. For a brief description, not all possible combinations of the technical features in the foregoing embodiments are described. However, the combinations of these technical features should be considered to fall within the scope of this specification as long as the combinations are not contradictory.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An unmanned aerial vehicle return method, comprising:
determining a distance between a first return point and a current location of a terminal when a return condition of an unmanned aerial vehicle is triggered;
determining a second return point according to the current location of the terminal when the distance is greater than a preset distance threshold; and
determining a flight path according to a current location of the unmanned aerial vehicle and the second return point, and returning to the second return point according to the flight path.

2. The method according to claim 1, wherein the determining a second return point according to the current location of the terminal comprises:
determining, according to the current location of the terminal, that the second return point is any location having a distance within a preset range to the current location of the terminal.

3. The method according to claim 2, wherein the determining, according to the current location of the terminal, that the second return point is any location having a distance within a preset range to the current location of the terminal comprises:
determining, according to the current location of the terminal, that the second return point is the current location of the terminal.

4. The method according to claim 1, wherein the preset distance threshold is related to an environment in which the terminal is located.

5. The method according to claim 1, wherein the return condition comprises:
the unmanned aerial vehicle detects that a remaining electricity quantity of the unmanned aerial vehicle is less than or equal to an electricity quantity threshold; or
the unmanned aerial vehicle completes a flight task; or
the unmanned aerial vehicle receives a return instruction; or
the unmanned aerial vehicle fails to communicate with the terminal.

6. The method according to claim 5, wherein if the return condition comprises that the unmanned aerial vehicle detects that the remaining electricity quantity of the unmanned aerial vehicle is less than or equal to the electricity quantity threshold,
the electricity quantity threshold is determined based on a distance between the unmanned aerial vehicle and the second return point and a flight speed of the unmanned aerial vehicle.

7. The method according to claim 1, further comprising:
calculating a return time according to a distance between the current location of the unmanned aerial vehicle and the second return point and the flight speed of the unmanned aerial vehicle; and
sending the return time to the terminal, the terminal being configured to display the return time.

8. A computer readable storage medium, storing a computer program, wherein the program, when executed by a processor, implements the unmanned aerial vehicle return method according to claim 1.

9. An unmanned aerial vehicle, comprising: a processor, and a memory storing a computer program executable by the processor; wherein when the computer program is executed by the processor, the processor is configured to:
determine a distance between a first return point and a current location of a terminal when a return condition of the unmanned aerial vehicle is triggered;
determine a second return point according to the current location of the terminal when the distance is greater than a preset distance threshold; and
determine a flight path according to a current location of the unmanned aerial vehicle and the second return point, and returning to the second return point according to the flight path.

10. The unmanned aerial vehicle according to claim 9, wherein the processor is further configured to:
determine, according to the current location of the terminal, that the second return point is any location having a distance within a preset range to the current location of the terminal.

11. The unmanned aerial vehicle according to claim 10, wherein the processor is further configured to:
determine, according to the current location of the terminal, that the second return point is the current location of the terminal.

12. The unmanned aerial vehicle according to claim 10, wherein the processor is further configured to:
calculate a return time according to a distance between the current location of the unmanned aerial vehicle and the second return point and the flight speed of the unmanned aerial vehicle; and
send the return time to the terminal, the terminal being configured to display the return time.

13. The unmanned aerial vehicle according to claim 9, wherein
the preset distance threshold is related to an environment in which the terminal is located.

14. The unmanned aerial vehicle according to claim 9, wherein the processor is further configured to:
detect that a remaining electricity quantity of the unmanned aerial vehicle is less than or equal to an electricity quantity threshold; or
complete a flight task; or
receive a return instruction; or
fail to communicate with the terminal.

15. The unmanned aerial vehicle according to claim 14, wherein
the electricity quantity threshold is determined based on a distance between the unmanned aerial vehicle and the second return point and a flight speed of the unmanned aerial vehicle.
